(19) United States
(12) Patent Application Publication
(10) Pub. No.: US 2003/0118042 A1
(43) Pub. Date: Jun. 26, 2003

(54) Packet communications method and apparatus

(76) Inventors: Mitsuhiro Nishida, Fukuoka (JP); Chiaki Tahara, Fukuoka (JP); Kousuke Nakamura, Onojo (JP); Yumiko Shigeoka, Fukuoka (JP); Koki Kurokawa, Chikushino (JP); Hironori Kadota, Fukuoka (JP); Seiji Miyata, Kitakyshu (JP); Keiichi Furukawa, Kawasaki (JP); Akihisa Kawaguchi, Kawasaki (JP); Takatsugu Kurokawa, Kawasaki (JP)

Correspondence Address: KATTEN MUCHIN ZAVIS ROSENMAN, 575 MADISON AVENUE, NEW YORK, NY, 10022-2585, US

(21) Appl. No.: 10/313,528

(22) Filed: Dec. 6, 2002

(30) Foreign Application Priority Data
Dec. 7, 2001 (JP) 2001-374149

(51) Int. Cl. H04L 12/28; H04L 12/56

(52) U.S. Cl. 370/404

(57) ABSTRACT

A packet communications method whereby reliable and high-speed communication is possible without depending on the processing of other layers, and also whereby the system configuration can be flexibly changed without making circuit changes to the receiving unit. A device on the sending side adds a packet identifier to the packet and sends this packet along with a packet identical to this packet to a device on the receiving side. The device on the receiving side receives the packets sent from the device on the sending side, checks the packets for errors and, based on the packet identifier, determines whether or not the error-free packets have arrived first. If the packet arrived first, the packet with the packet identifier removed is subject to sending to a terminal, but if it arrived last, the packet is not subject to sending to the terminal, so only error-free packets are subject to the determination of whether it arrived first or not, and thus the determination can be performed accurately.

### BACKGROUND OF THE INVENTION

1. Technical Field of the Invention

The present invention relates to a ring-shaped packet communications method, and particularly to a packet communications method in a redundant multi-path transmission route.

2. Description of Related Art

A conventional example of this type of packet communications method is disclosed in the publication of unexamined Japanese patent application (Kokai) No. JP-A-H1-208050, which is described based on FIG. 11. FIG. 11 is a schematic block diagram of a conventional packet communications device.

In the conventional packet communications method according to the aforementioned FIG. 11, the packet communications method involves performing two-way packet communications by means of a pair of redundant communications circuits 303 and 308. The device constitutes packet sending units 301 and 306 that send packets to the communications circuits 303 and 308, packet receiving units 304 and 309 that receive packets from the communications circuits 303 and 308, numbering units 300 that adds ascending-order or descending-order sequence numbers to sent packets, and first-come-first-served packet selection unit 305 that compares the number of the packet first received against the numbers of packets from the other communications circuit 303 (or 308) and performs selection of packets with numbers having the same value on the principle of first-come-first-served.

A description follows of the operation of the conventional packet communications method based on the aforementioned constitution. At the time of sending of a packet, the numbering unit 300 adds a number to the packet, and this packet with the packet number added is sent by the packet sending unit 301 and 306 to the communications circuits 303 and 308. The packets sent over the communications circuits 303 and 308 are transmitted to the first-come-first-served packet selection unit 305 and packets are taken in first-come order of packets based on the numbers within the received packets, and in the case that a packet with the same number as a packet already taken in is received from the other communications circuit, the packet in question is discarded.

Similarly, another conventional example of this type of packet communications method is disclosed in the publication of unexamined Japanese patent application (Kokai) No. JP-A-2000-115244, which is described based on FIG. 12. FIG. 12 is a schematic block diagram of a conventional packet communications device.

In the conventional packet communications method according to the aforementioned FIG. 12, the sending device has: a splitter 402 that splits contiguous data into data packets, a replicator 403 that replicates data packets into multiple data packets, and network connection devices 404, 405, 406 and 407 that perform the sending and receiving of data packets, while the receiving device has: network connection devices 409, 410, 411 and 412 that perform the sending and receiving of data packets, a data selector 413 that selects valid data packets from among a plurality of data packets, and an assembler 414 that assembles contiguous data from the selected data packets.

A description follows of the operation of the conventional packet communications method based on the aforementioned constitution. Contiguous data output from the application terminal 401 is input to the splitter 402, and the splitter 402 splits the contiguous data into data packets which are the units of communication over the network. The data packets generated in this splitter 402 are transferred to the replicator 403, and the replicator 403 replicates the data packets generated in the splitter 402 to generate n (n is an arbitrary constant) data packets. The data packets generated in the splitter 402 and the n data packets replicated by the replicator 403 are sent via the network connection devices (from 404-407), the network 408 and network connection devices (409-412) to the data selector 413.

Based on the arrival times, the data selector 413 selects from among the data packets transferred from the sending side only the first data packet, transfers this to the assembler 414 and discards the remaining data packets. The assembler 414 restores the data packets selected by the data selector 413 to contiguous data, which is transferred to the application terminal 415. Thereby, the contiguous data is recreated at the application terminal 415.

When one of the aforementioned types of conventional packet communications is performed to exchange data among a plurality of terminals, it is necessary to have a receiving device 502 such as that shown in FIG. 13 which shows a schematic block diagram of the reception unit of a conventional packet communications device. This reception unit has a configuration wherein a plurality of transmission path selector blocks 524 that switch the input among a plurality of sent data packets are provided corresponding to each of the plurality of other communications terminals.

Because conventional packet communications methods are constituted as described above, when the received packet is compared with packets already taken in and the judgment of which arrived first is made, this is based on the numbers applied to the packets, e.g. sequence numbers, so it is necessary to separately apply the storage address of the packet that arrived first, and the various operations of reading and comparing these stored packets becomes complicated and accurate determination is difficult. There are also problems in that there may be errors in the judgment of identical packets, such that packets taken later in time seem identical to packets taken in previously, and may be taken in, or packets that had not been taken in at the current point in time may not be taken in. To wit, it becomes necessary to perform communications control such as discarding or resending packets on other layers due to redundant packets being taken in or packets not yet taken in being discarded.

In addition, in the aforementioned conventional packet communications method, the validity of the sent data packets is determined depending on the first-come order for the time at which the plurality of data packets arrive, so the management of the arrival times becomes complex and also there are problems in that the arrival time and data packet cannot be uniquely identified, so the determination of whether data packets are identical or not becomes difficult, so that packets identical to packets taken in previously may be taken in, or packets that had not been taken in at the current point in time may not be taken in.

In addition, because a plurality of transmission path selectors corresponding to the plurality of other terminals is provided in each of the aforementioned receiving units, in a system configuration in which another terminal is added, it is necessary to provide additional transmission path selectors in all of the plurality of other terminals, thus leading to an increase in the size of the circuits and also the problem of a system configuration that is not flexible and easily changed.

The object of the present invention is to solve the aforementioned problems and provide a packet communications method that permits reliable and high speed communications without relying on the processing of other layers, and also allows the system configuration to be changed flexibly without making changes to the circuits of the receiving unit.

### SUMMARY OF THE INVENTION

The packet communications method according to the present invention includes: a packet communications method whereby a plurality of devices that connect terminals are connected in a ring shape, and the communication of data among the devices thus connected is performed via a plurality of transmission paths, thereby implementing packet communications among the terminals wherein, the sending-side device adds to each packet a different node identifier for each node and information that indicates the order of sending of packets as a packet identifier, and sends packets that are identical to the packet to the receiving-side device via the plurality of transmission paths. The receiving-side device receives the packet sent from the sending-side device, checks the received packets for errors and, based on the packet identifier, determines whether the error-free packets arrived first or not. If the packet arrived first, the packet is subject to sending to the terminal, but if the packet arrived last, the packet is not subject to sending to the terminal.

With this invention as such, the sending-side device adds a packet identifier to each packet, and sends packets that are identical to the packet to the receiving-side device, and this receiving-side device receives the packet sent from the sending-side device, checks the received packets for errors and, based on the packet identifier, determines whether the error-free packets arrived first or not. If the packet arrived first, the packet is subject to sending to the terminal, but if the packet arrived last, the packet is not subject to sending to the terminal, so the determination of whether only error-free packets arrived first can be made accurately.

In addition, the packet communications method according to the present invention is such that: at the time that the receiving-side device determines whether the packets arrived first or not, it is determined whether or not the packets and other identical packets sent from other transmission paths have already been stored at the address identified by the node identifier and packet sending order information. Therefore, received packets are stored with the first-arrived packets stored at the address identified from the node identifier and information on the sending order of packets, so the judgment of identical packets can be done without applying separate address numbers, also the determination of whether it is the first arrived or not can be performed easily and rapidly, so the judgment of first arrived or not can be performed accurately as only error-free packets are subject to sending, and thus accurate processing is possible with a simple operation and more reliable communications can be achieved.

In addition, if necessary, in the packet communications method according to the present invention, at the time that the receiving-side device determines whether the packets arrived first or not, the data and/or symbol information of the packet may also be referenced. At the time that the receiving-side device determines whether the packets judged to be error-free arrived first or not, the determination of whether the packets arrived first or not is made based on the data and/or symbol information of the packet in addition to the packet identifier, so after a sequence of data split into a plurality of packets is sent, if another sequence of data is split into packets and sent, it is possible to prevent processing errors wherein the same packet is redundantly subject to sending or the first-arrived packet is not subject to sending, and thus reliable communication can be achieved.

In addition, the packet communications device according to the present invention is one whereby a plurality of devices that connect terminals are connected in a ring shape, and the communication of data among the devices thus connected is performed via a plurality of transmission paths, thereby implementing packet communications among the terminals, wherein the sending-side device has an identifier adding block that adds to each packet a different node identifier for each node and information that indicates the sending order of the packets as a packet identifier, and has a sending block that sends packets that are identical to the packet to the receiving-side device via the plurality of transmission paths. The receiving-side device has a receiving block that receives the packet sent from the sending-side device, has a checking block that checks the received packets for errors and has a control block that, based on the packet identifier, determines whether the error-free packets arrived first or not; if the packet arrived first, the packet is subject to sending to the terminal, but if the packet arrived last, the packet is not subject to sending to the terminal.

In addition, the packet communications device according to the present invention may, if necessary, be one wherein at the time that the control block of the receiving-side device determines whether the packets arrived first or not, it is determined whether or not the packets and other identical packets sent from other transmission paths have already been stored at the address identified by the node identifier and packet sending order information.

In addition, the packet communications device according to the present invention may, if necessary, be one wherein at the time that the control block of the receiving-side device determines whether the packets arrived first or not, the data and/or symbol information of the packet is also referenced.

### BRIEF DESCRIPTION OF THE DRAWINGS

FIG. 1 is a schematic block diagram of the sending unit in the packet communications device according to an embodiment of the present invention;

FIG. 2 is a schematic block diagram of the receiving unit in the packet communications device according to an embodiment of the present invention;

FIG. 3 is a detail block diagram of the control block of FIG. 2;

FIG. 4 is a ring-shaped network according to an embodiment of the present invention;

FIG. 5 is a processing mode diagram with respect to packets in the checking block and control block of the receiving unit in the packet communications device according to an embodiment of the present invention;

FIG. 6 is a flowchart of the operation of the sending unit in the packet communications device according to an embodiment of the present invention;

FIG. 7 is a flowchart of the operation of the receiving unit in the packet communications device according to an embodiment of the present invention;

FIG. 8 is a flowchart of the detailed operation of the processing (Step 24) in the control block of FIG. 7;

FIG. 9 shows the packets and frame configuration on the sending unit in the packet communications device according to an embodiment of the present invention;

FIG. 10 shows the packets and frame configuration on the receiving unit in the packet communications device according to an exemplary Embodiment of the present invention;

FIG. 11 is a schematic block diagram of a conventional packet communications device;

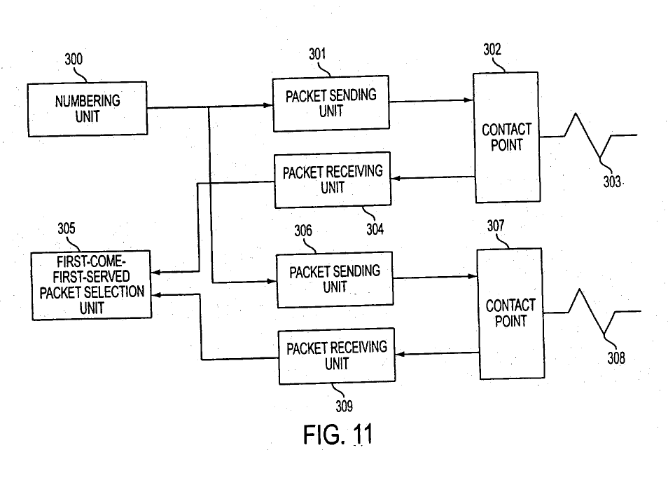

FIG. 12 is a schematic block diagram of a conventional packet communications device; and

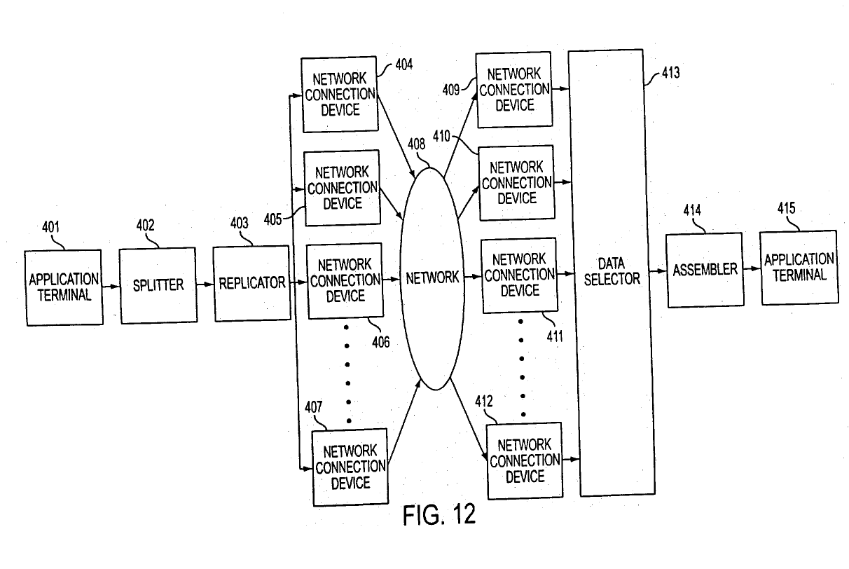

FIG. 13 is a schematic block diagram of the receiving unit of a conventional packet communications device.

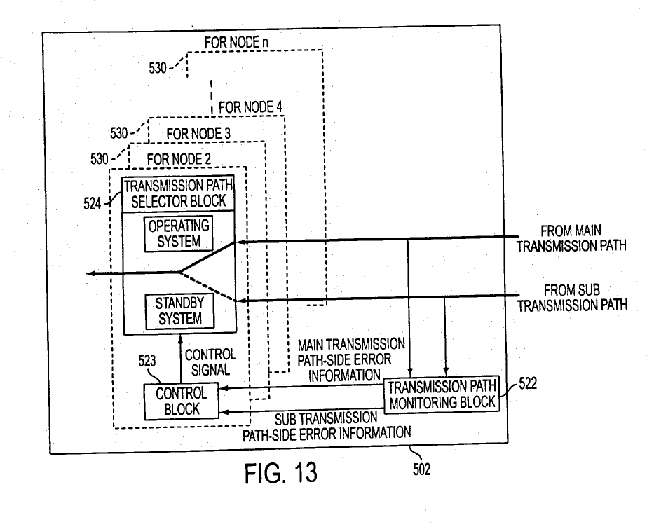

### DETAILED DESCRIPTION

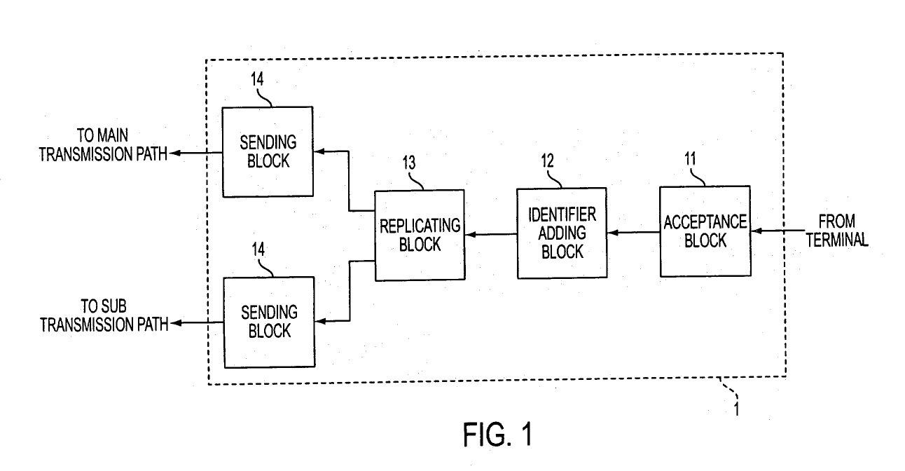

An explanation of the packet communications device that applies the packet communications method according to an exemplary Embodiment of the present invention is made with reference to FIG. 1 through FIG. 10.

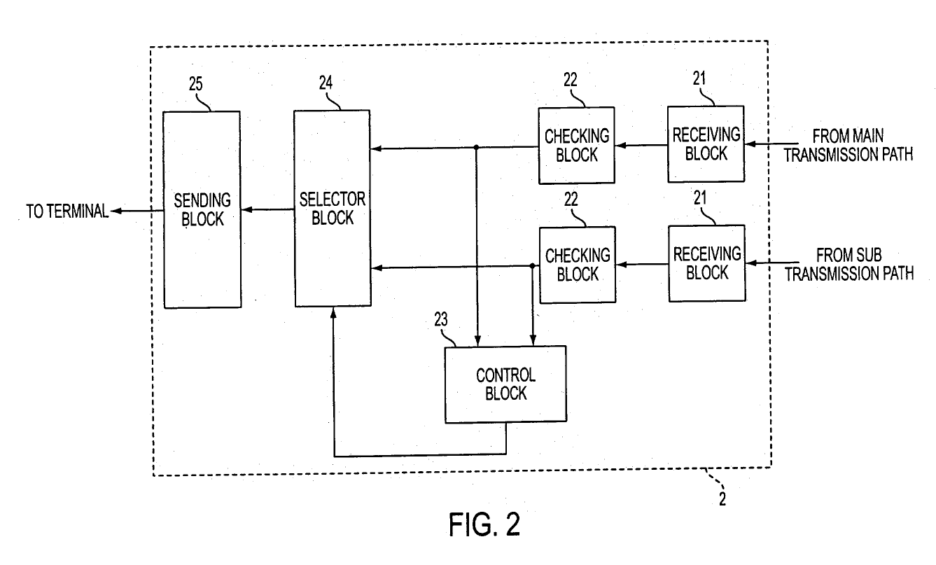

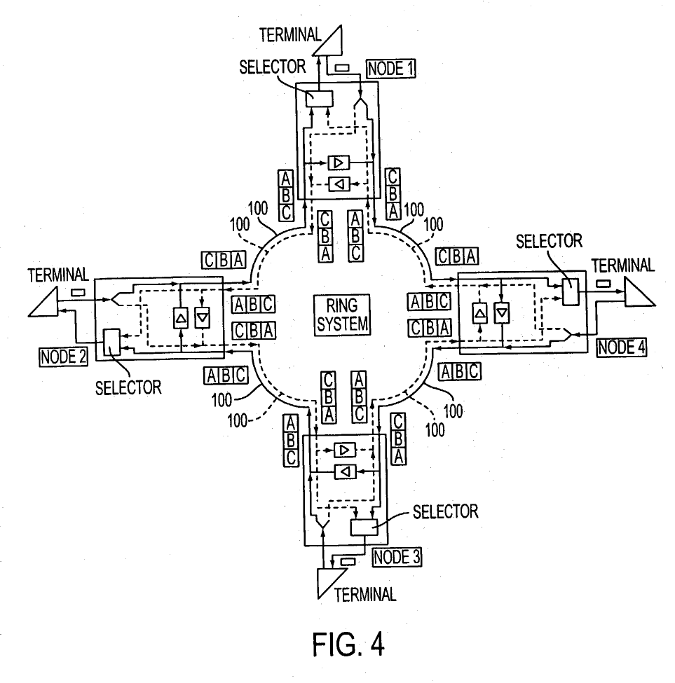

As illustrated in FIG. 1-FIG. 10, the packet communications devices to which the packet communications method according to this embodiment is applied, are connected via a ring-shaped transmission path 100 (see FIG. 4), and each consists of a sending unit 1 (FIG. 1) that replicates packets with packet identifiers added for the other packet communications devices connected to this transmission path 100, and sends these packets along with the replicated packets each via different transmission paths 100, along with a receiving unit 2 (FIG. 2) that implements the receiving process of receiving packets sent from other packet communications devices via the transmission path 100, checking them for errors and, if the packets are determined to be error-free, taking in the packet that arrived first and discarding other packets.

The sending unit 1 includes an acceptance block 11 that accepts packets sent from a terminal which is the top layer in the OSI model (Open System Interconnection basic reference model), an identifier adding block 12 that adds to the packet to be sent a node number that differs for each node, and a sequence number that is different for each packet as a packet identifier, a replicating block 13 that replicates a packet to be identical to the original packet, and a sending block 14 that sends these two identical packets to the receiving unit 2 via the transmission path 100.

The receiving unit 2 includes a receiving block 21 that receives packets sent by the sending unit 1, a checking block 22 that takes in the packets that this receiving block 21 has received and checks them for errors, a selector block 24 that takes in the packets taken in by the checking block 22, a control block 23 that determines whether the packets taken in from the checking block 22 arrived first or not, and if the packet is not the first to arrive, outputs to the selector block 24 a control signal which is a signal with the content of ordering the packet to be discarded and a sending block 25 that sends the packet taken in by the selector block 24 to the terminal.

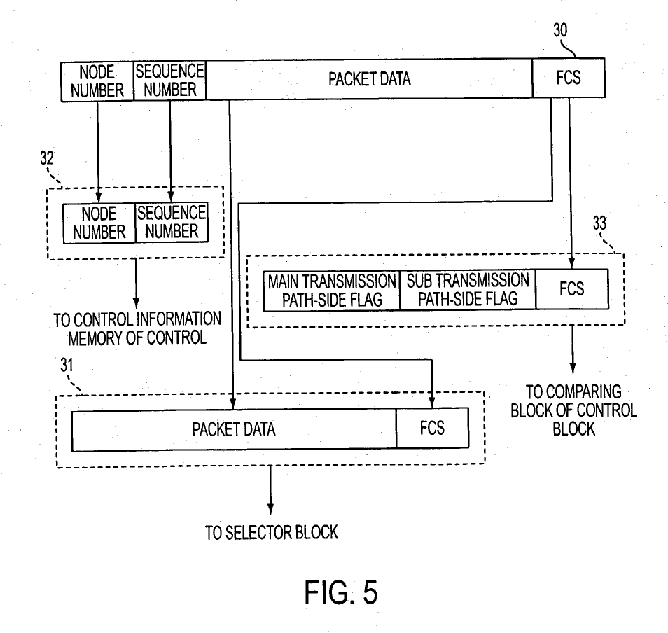

As shown in FIG. 5, the aforementioned packets consist of the packet data and a FCS (Frame Check Sequence) which is a symbol used to check the packets for errors. The identifier adding block 12 of sending unit 1 adds the node number which is a different identifier for each node and the sequence number which is a different identifier for each packet and then the packets are sent to the receiving unit 2 from the sending block 14 of the sending unit 1.

Based on the FCS within a packet taken in from the receiving block 21, the checking block 22 checks the packet for errors, and if the packet is error-free, sends the node number, sequence number and FCS to the control block 23 (see FIG. 5) and also sends the packet data and FCS to the selector block 24 (see FIG. 5), but if the packet has errors, the packet is discarded.

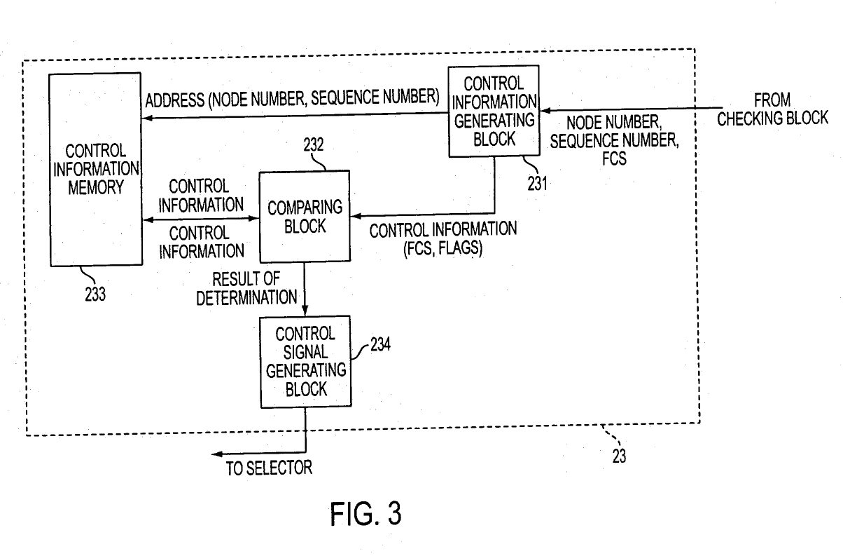

The aforementioned control block 23 (FIG. 3) includes a control information generating block 231 that takes in from the checking block 22 the node number, sequence number and FCS of error-free packets, adds a flag to this FCS and generates control information; a control information memory 233 that, upon input of the address identified by the node number and sequence number from this control information generating block 231, reads control information for the storage region with this address and executes a write process; a comparing block 232 that compares the control information of the packet generated and output by said control information generating block 231 against the control information recorded in the control information memory 233 and determines whether or not the packet arrived first; and a control signal generating block 234 that sends out a control signal based on the results of determination in the comparing block 232.

In this manner, the control block 23 uses the packet node number and sequence number taken in by the control information generating block 231 as the memory address of the control information memory 233, and stores control information in the appropriate memory region. In addition, the control information generating block 231 adds to the FCS of the packet a region for writing a flag for determining whether or not the packet arrived first and sends it as control information to the comparing block 232, and then the comparing block 232 reads out control information in the control information memory 233 based on the address taken in from the control information generating block 231.

The comparing block 232 makes a determination of first arrival or not based on this control information and the control information taken in from the control information generating block 231 and the comparing block 232 sends the result of determination to the control signal generating block 234. If the result of determination is that of first arrival, the control signal generating block 234 sends to the selector block 24 a control signal to the effect of “take in packet” but if the result of determination is that of not first arrival, the control signal generating block 234 sends to the selector block 24 a control signal to the effect of “discard packet.”

The selector block 24 accepts input of a control signal from the control block 23 and if the control signal indicates “take in packet,” takes in the packet data and FCS sent by the checking block 22, but if the control signal indicates “discard packet,” discards the packet data and FCS.

The sending block 25 sends the packet data and FCS taken in by the selector block 24 to the terminal which is the top layer in the OSI model.

Following is an example of the operation of the packet communications device to which is applied the packet communications method according to this embodiment based on the aforementioned constitution, divided into the sending operation in the sending unit 1 and the receiving operation in the receiving unit 2. In the sending unit 1, the sending operation is performed each time a packet is sent, and in the receiving unit 2, the receiving operation is performed each time a packet is received.

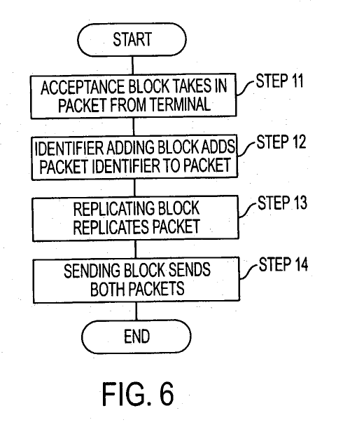

The sending operation in the sending unit 1 is described based on FIG. 6. The acceptance block 11 takes in the packet data and FCS generated by the terminal and sends it to the identifier adding block 12 (Step 11). The identifier adding block 12 takes in the packet data and FCS from the acceptance block 11, and adds a node number depending on the terminal and a sequence number depending on the packet as the packet identifier, and sends them to the replicating block 13 (Step 12).

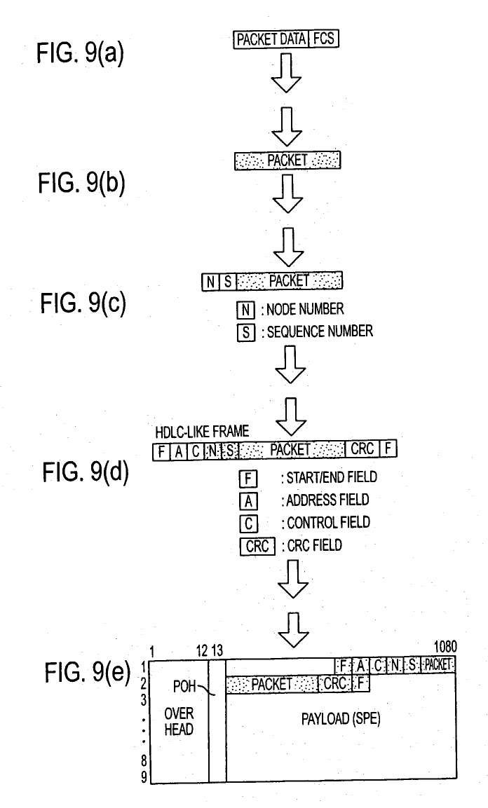

The replicating block 13 takes in the packet from the identifier adding block 12 and replicates it with an identical packet, and sends the packet taken in and the replicated packet to the sending block 14 leading to the main transmission path and the sending block 14 leading to the sub transmission path (Step 13). Each of the sending blocks 14 sends its packet to the receiving unit 2 of the terminal (Step 14). In the sending unit 1, the packet and frame are constituted as shown in FIG. 9, and the sending unit 1 adds the node number and sequence number to the packet (see FIGS. 9(a) and (b)) taken in from the terminal, giving a packet with the packet identifier added (see FIG. 9(c)) and then frame formation is performed on the bottom layer as shown in FIGS. 9(d) and (e). Here, each packet travels by a different transmission path to reach the receiving unit 2, so depending on the distance and state of each transmission path, the times at which the identical packets reach the receiving unit 2 are typically different.

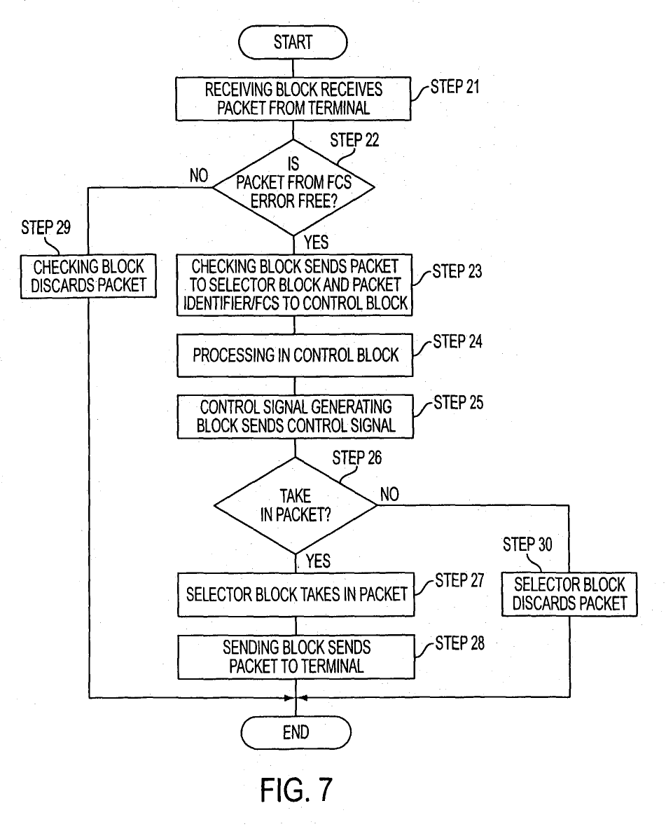

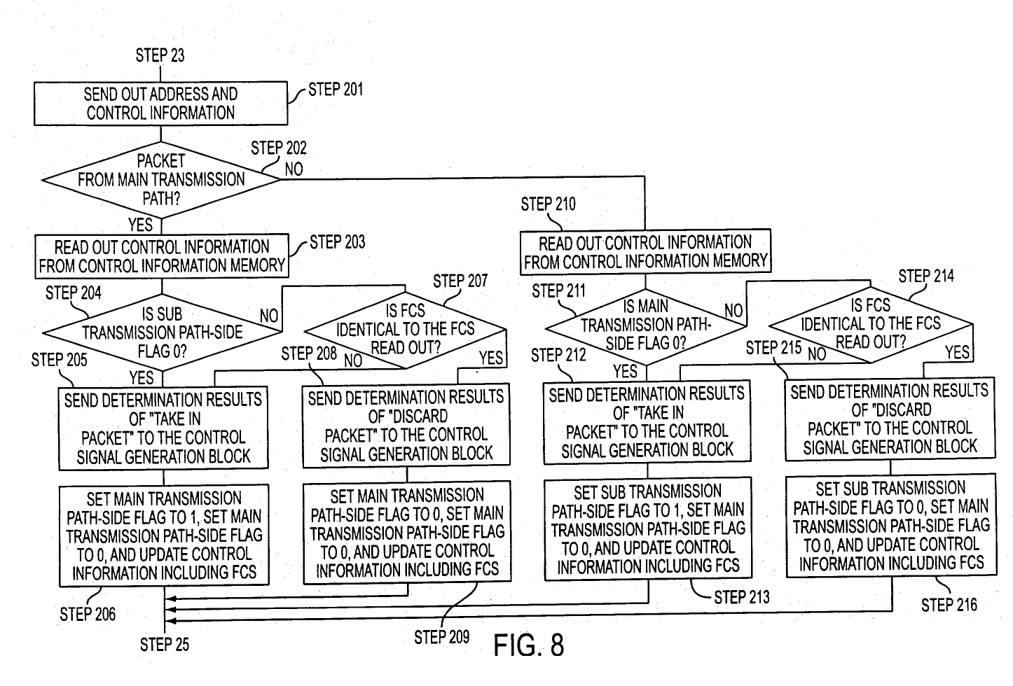

The receiving operation in the receiving unit 2 is described based on FIG. 7 and FIG. 8. The receiving block 21 receives a packet through the transmission path from the sending block 14 of said sending unit 1, and sends it to the checking block 22 (Step 21). The checking block 22 takes in the packet from the receiving block 21 and checks the entire packet for errors based on the FCS within the packet (Step 22). If the packet is determined to be error-free, the checking block 22 sends the node number, sequence number and FCS to the control block 23 and also, as shown in FIG. 5, sends the packet data and FCS to the selector block 24 (Step 23). The control block 23 takes in the node number, sequence number and FCS from the checking block 22 and performs processing in the control block 23 as described below (Step 24).

Based on the results of the aforementioned processing in the control block 23, the control signal generating block 234 (FIG. 3) generates a control signal and sends it to the selector block 24 (Step 25). Based on the control signal input from the control block 23, the selector block 24 determines whether or not to take in the packet (Step 26). If the control signal is determined to be a signal of “take in packet,” the packet data and FCS sent out by the checking block 22 are taken in and the packet data and FCS are sent out to the sending block 25 (Step 27), and the sending block 25 takes in the packet data and FCS from the selector block 24 and sends it out to the terminal which is the top layer in the OSI model (Step 28). If in Step 22 the checking block 22 determines that the packet contains errors, the packet is discarded (Step 29). If in Step 26 the control signal is determined to be a signal of “discard packet” the selector block 24 discards the packet data and FCS (Step 30).

As shown in FIG. 8, the processing in the control block 23 (Step 24) consists of the node number, sequence number and FCS sent out from the checking block 22 being taken in by the control information generating block 231 to generate an address in the control information memory 233 from the node number and sequence number, and also, adding to the FCS a main transmission path-side flag, which is a flag that indicates whether or not a packet with an identical node number and sequence number has already arrived through the main transmission path, and a sub transmission path-side flag, which is a flag that indicates whether or not a packet with an identical node number and sequence number has already arrived through the sub transmission path, thus generating control information. This main transmission path-side flag and sub transmission path-side flag each consists of a flag region that is set to “1” if an identical packet has already arrived or to “0” if an identical packet has not yet arrived, being initialized to “0” when first generated by the control information generating block 231. The address thus generated is sent out to the control information memory 233 and also, the control information is sent out to the comparing block 232 (Step 201). The comparing block 232 takes in control information from the memory region identified by the address and determines from which of the transmission paths, the main transmission path or the sub transmission path, the receiving block 21 has received the packet (Step 202).

When this comparing block 232 determines that the packet had been received by the receiving block 21 through the main transmission path, based on this address, the comparing block 232 reads out control information from the control information memory 233 (Step 203) and the comparing block 232 determines whether or not the sub transmission path-side flag of the control information is 0 (Step 204). If the comparing block 232 determines that the sub transmission path-side flag is 0, it sends a result of determination to the effect of “take in packet” to the control signal generating block 234 (Step 205) and also, within the control information taken in from the control information generating block 231, sets the main transmission path-side flag to “1” and the sub transmission path-side flag to “0,” and thus the comparing block 232 updates in the control information memory 233 the control information taken in from the control information generating block 231 based on the address (Step 206). Thereby, the control information taken in from the control information generating block 231 overwrites the control information stored in the control information memory 233.

In Step 204, if the comparing block 232 determines that the sub transmission path-side flag is not 0, then the FCS within the control information read out from the control information memory is compared against the FCS within the control information taken in from the control information generating block 231, thereby determining whether they are identical or not (Step 207). If the comparing block 232 determines that they are not identical, control proceeds to Step 205, but if the comparing block 232 determines that they are identical, it sends out a result of determination to the effect of “discard packet” to the control signal generating block 234 (Step 208) and also, within the control information taken in from the control information generating block 231, sets the main transmission path-side flag to “0” and the sub transmission path-side flag to “0,” and thus the comparing block 232 updates in the control information memory 233 the control information taken in from the control information generating block 231 based on address (Step 209).

In Step 202, if the comparing block 232 determines that the packet had not been received by the receiving block 21 through the main transmission path, based on this address, the comparing block 232 reads out control information from the control information memory 233 (Step 210) and the comparing block 232 determines whether or not the main transmission path-side flag of the control information is “0” (Step 211). If the comparing block 232 determines that the main transmission path-side flag is “0,” it sends a result of determination to the effect of “take in packet” to the control signal generating block 234 (Step 212) and also, within the control information taken in from the control information generating block 231, sets the sub transmission path-side flag to “1” and the main transmission path-side flag to “0,” and thus the comparing block 232 updates in the control information memory 233 the control information taken in from the control information generating block 231 based on the address (Step 213).

In the aforementioned Step 211, if the comparing block 232 determines that the main transmission path-side flag is not “0,” then the FCS within the control information read out from the control information memory 233 is compared against the FCS within the control information taken in from the control information generating block 231, thereby determining whether they are identical or not (Step 214). If the comparing block 232 determines that they are not identical, control proceeds to Step 212, but if the comparing block 232 determines that they are identical, it sends out a result of determination to the effect of “discard packet” to the control signal generating block 234 (Step 215) and also, within the control information taken in from the control information generating block 231, sets the sub transmission path-side flag to “0” and the main transmission path-side flag to “0,” and thus the comparing block 232 updates in the control information memory 233 the control information taken in from the control information generating block 231 based on the address (Step 216).

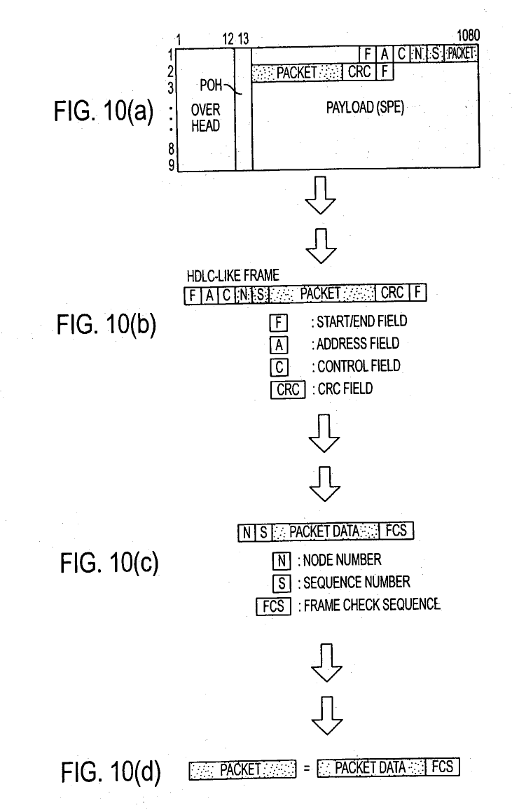

In the receiving unit 2, the packet and frame are constituted as shown in FIG. 10, and in the order opposite of that done by the sending unit 1, the receiving unit 2 performs processing on the frames in the bottom layer (see FIGS. 10(a) and (b)) and then adds the packet identifier (see FIG. 10(c)). Thus, after the processing on the bottom layer, the node number and sequence number are removed from the packet of FIG. 10(c) taken in by the receiving unit 2 thus giving the packet shown in FIG. 10(d).

By means of the packet communications device to which the packet communications method according to this embodiment is applied, in the sending unit 1, the identifier adding block 12 adds a packet identifier to the packet and the replicating block 13 replicates the packet with the packet identifier added to generate an identical packet and sends both the packet and the replicated packet to the receiving unit 2, and in this receiving unit 2, the receiving block 21 receives the packet sent from the sending unit 1, the checking block 22 checks the packet for errors, and if error-free, uses the packet identifier and symbol information to determine whether the identical packet had arrived first or not. If it arrived first the selector block 24 takes in the packet with the packet identifier removed and sends it out to the terminal; if it did not arrive first, the packet is discarded. Thus, only packets determined to be error-free in the checking block 22 can be subject to the determination of whether they are the first arrived packets or not, so the determination can be performed reliably, and thus even in the case in which after a sequence of data split into a plurality of packets is sent, if another sequence of data is split into packets and sent, it is possible to prevent processing errors wherein the same packet is redundantly subject to sending or the first-arrived packet is not subject to sending, and thus reliable communication can be achieved.

Note that in the packet communications device to which the packet communications method according to an exemplary Embodiment is applied, the case in which packets arrive simultaneously at the receiving block 21 through the main transmission path and the receiving block 21 through the sub transmission path in the receiving unit 2 is not described, but in the case that packets arrive simultaneously, the subsequent processing can be performed on the packet that arrived at the receiving block 21 through one or the other transmission paths determined according to ordinary priority, and the packet that arrives at the receiving block 21 through the other transmission path can be put on standby.

In addition, in the packet communications device, it is also possible to store the first-arrived packet in the control information memory 233 at the address identified by means of the node number and sequence number of the packet received by comparing block 232, and thus it is possible to determine identical packets and also make the determination of first arrival or not simply and quickly without applying a separate address number. Thus, the determination of first arrival can be performed accurately by the comparing block 232 on only the error-free packets, so reliable communication can be achieved without taking in packets that were already taken in or discarding packets that were not taken in.

As described above, according to the present invention, the device on the sending side adds a packet identifier to the packet and sends this packet along with a packet identical to this packet to the device on the receiving side. This device on the receiving side receives the packets sent from the device on the sending side, checks the packets for errors and, based on the packet identifier, determines whether or not the error-free packets have arrived first. If the packet arrived first, the packet with the packet identifier removed is subject to sending to the terminal, but if it arrived last, the packet is not subject to sending to said terminal, so only error-free packets are subject to the determination of whether it arrived first or not, and thus it has meritorious effects in that the determination can be performed accurately and reliable communication can be achieved.

In addition, with the present invention, received packets are stored with the first-arrived packets stored at the address identified from the node identifier and information on the sending order of packets, so it has meritorious effects in that the judgment of identical packets can be done without applying separate address numbers, and also, the determination of whether it is the first arrived or not can be performed easily.

In addition, with the present invention, at the time that the receiving-side device determines whether the packets judged to be error-free arrived first or not, the determination of whether the packets arrived first or not is made based on the data and/or symbol information of the packet in addition to the packet identifier, so after a sequence of data split into a plurality of packets is sent, if another sequence of data is split into packets and sent, so it has meritorious effects in that it is possible to prevent processing errors wherein the same packet is redundantly subject to sending or the first-arrived packet is not subject to sending.

1. A packet communications method whereby a plurality of devices that connect terminals are connected in a ring shape, and the communication of data among said devices thus connected is performed via a plurality of transmission paths, thereby implementing packet communications among said terminals, said method comprising the steps of:
at a sending-side device adding to each packet a different node identifier for each node and information that indicates the order of sending of packets as a packet identifier; and
sending packets that are identical to said packet to a receiving-side device via said plurality of transmission paths; and
at a receiving-side device receiving the packet sent from said sending-side device;
checking said received packets for errors; and
based on said packet identifier, determining whether the error-free packets arrived first or not;
wherein if said packet arrived first, said packet is subject to sending to said terminal, but if said packet arrived last, said packet is not subject to sending to said terminal.

2. The packet communications method according to claim 1 wherein,
at the time that said receiving-side device determines whether said packets arrived first or not, it is determined whether or not said packets and other identical packets sent from other transmission paths have already been stored at an address identified by the node identifier and packet sending order information.

3. The packet communications method according to claim 1, wherein,
at the time that said receiving-side device determines whether said packets arrived first or not, the data and/or symbol information of said packet is also referenced.

4. The packet communications method according to claim 1, wherein,
at the time that said receiving-side device determines whether said packets arrived first, the data and symbol information of said packet is also referenced.

5. The packet communications method according to claim 1, wherein,
at the time that said receiving-side device determines whether said packets arrived first or not, the symbol information of said packet is also referenced.

6. The packet communications method according to claim 2, wherein,
at the time that said receiving-side device determines whether said packets arrived first or not, the data and/or symbol information of said packet is also referenced.

7. A packet communications system whereby a plurality of devices that connect terminals are connected in a ring shape, and the communication of data among said devices thus connected is performed via a plurality of transmission paths, thereby implementing packet communications among said terminals,
said packet communications system comprising:
a sending-side device having an identifier adding block that adds to each packet a different node identifier for each node and information that indicates the order of sending of packets as a packet identifier, and has a sending block that sends packets that are identical to said packet to a receiving-side device via said plurality of transmission paths; and
a receiving-side device having a receiving block that receives the packet sent from said sending-side device, has a checking block that checks said received packets for errors and has a control block that, based on said packet identifier, determines whether the error-free packets arrived first or not; if said packet arrived first, said packet is subject to sending to said terminal, but if said packet arrived last, said packet is not subject to sending to said terminal.

8. The packet communications system according to claim 7 wherein, at the time that said control block of said receiving-side device determines whether said packets arrived first or not, it is determined whether or not said packets and other identical packets sent from other transmission paths have already been stored at an address identified by the node identifier and packet sending order information.

9. The packet communications system according to claim 7 wherein,
at the time that said control block of said receiving-side device determines whether said packets arrived first or not, data and/or symbol information of said packet is also referenced.

10. The packet communications system of claim 7 wherein said transmission path sends said packet identifier for error free communication at one of a layer of a network without depending on processing of transmission at another of a layer of said network.

11. The packet communication system of claim 7 wherein said receiving-side device checks said received packets for errors and determines whether the error-free packets arrived first or not at least once when said packet is received.

12 A receiving-side device in a packet communications system whereby a plurality of devices that connect terminals are connected in a ring shape, and the communication of data among said devices thus connected is performed via a plurality of transmission paths, thereby implementing packet communications among said terminals, said receiving-side device comprising:
a receiving block that receives a packet sent from a sending-side device;
a checking block that checks said received packet for errors; and
a control block that, based on said packet identifier, determines whether an error-free packets arrived first or not; if said packet arrived first, said packet is subject to sending to said terminal, but if said packet arrived last, said packet is not subject to sending to said terminal.

13. The receiving-side device of claim 12, wherein said sending-side device adds to each packet a different node identifier for each node and information that indicates the order of sending of packets as a packet identifier, and sends packets that are identical to said packet to said receiving-side device via said plurality of transmission paths.

14. A sending-side device in packet communications system whereby a plurality of devices that connect terminals are connected in a ring shape, and the communication of data among said devices thus connected is performed via a plurality of transmission paths, thereby implementing packet communications among said terminals, said sending-side device comprising:
an identifier adding block that adds to each packet a different node identifier for each node and information that indicates the order of sending of packets as a packet identifier; and
a sending block that sends packets that are identical to said packet to a receiving-side device via said plurality of transmission paths, wherein
said packet identifier information utilized by said receiving-side device to determine which packet arrived first.

15. The sending-side device of claim 14, wherein said receiving-side device receives the packet sent from said sending-side device and checks said received packet for errors and, based on said packet identifier, determines whether the error-free packet arrived first or not; if said packet arrived first, said packet is subject to sending to said terminal, but if said packet arrived last, said packet is not subject to sending to said terminal.
